(19) United States
(12) Patent Application Publication
(10) Pub. No.: US 2012/0080151 A1
(43) Pub. Date: Apr. 5, 2012

(54) TIRE TOOL PROVIDING IMPROVED ACCESS TO VALVE HOLE

(76) Inventor: Tony A. Shipman, Cottonwood, CA (US)

(21) Appl. No.: 13/248,879

(22) Filed: Sep. 29, 2011

Related U.S. Application Data
(60) Provisional application No. 61/389,031, filed on Oct. 1, 2010.

(51) Int. Cl. B60C 25/14; B60C 25/18

(52) U.S. Cl. 157/1.3; 157/1.1

(57) ABSTRACT

Embodiments generally relate to a tire tool. In one embodiment, the tire tool includes a handle, and a first arm attached to the handle at a first arm proximal end, where the first arm includes a first arm distal end that is distant from the handle. The tire tool also includes a second arm attached to the handle at a second arm proximal end, where the second arm includes a second arm distal end that is distant from the handle, and where the first and second arm distal ends are separated to allow for placement of an air valve stem of an inner tube into an air valve hole of a wheel.

### CROSS REFERENCE TO RELATED APPLICATIONS

This application claims priority from U.S. Provisional Patent Application Ser. No. 61/389,031, entitled TIRE TOOL PROVIDING IMPROVED ACCESS TO VALVE HOLE, filed on Oct. 1, 2010, which is hereby incorporated by reference as if set forth in full in this application for all purposes.

### FIELD

One or more implementations relate generally to tools and more specifically to a tire tool for changing tires and tire tubes.

### BACKGROUND

Some tire tools facilitate replacing inner tubes of tires. Typically, such tire tools have an arm that is inserted between a tire and a wheel. A user utilizes a tire tool to pry a portion of the tire away from the wheel. The user can slide the tire tool around the edge of the wheel in order to expose the inner tube. This allows the user to pull the inner tube out and to insert a new inner tube.

### SUMMARY

Embodiments generally relate to a tire tool. In one embodiment, the tire tool includes a handle, and a first arm attached to the handle at a first arm proximal end, where the first arm includes a first arm distal end that is distant from the handle. The tire tool also includes a second arm attached to the handle at a second arm proximal end, where the second arm includes a second arm distal end that is distant from the handle, and where the first and second arm distal ends are separated to allow for placement of an air valve stem of an inner tube into an air valve hole of a wheel.

A further understanding of the nature and the advantages of particular embodiments disclosed herein may be realized by reference of the remaining portions of the specification and the attached drawings.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 illustrates a perspective a view of a tire tool, according to an embodiment.

FIG. 2 illustrates a side view of the tire tool, according to an embodiment.

FIG. 3 illustrates a close-up side view of the tire tool, according to an embodiment.

FIG. 4 illustrates a close-up bottom view of the tire tool, according to an embodiment.

FIG. 5 illustrates a close-up top perspective view of the tire tool, according to an embodiment.

FIG. 6 illustrates a close-up side view of the tire tool, including dimensions and angles, according to an embodiment.

FIG. 7 illustrates a close-up top view of the tire tool, including dimensions and angles, according to an embodiment.

FIG. 8 illustrates an example simplified flow diagram for using the tire tool, according to an embodiment.

FIG. 9 illustrates the tire tool being used to remove an inner tube from a wheel, according to an embodiment.

FIG. 10 illustrates the tire tool being used to enable access to an air valve hole of the wheel, according to an embodiment.

FIG. 11 illustrates a close-up view of the tire tool being used to enable an air valve stem of an inner tube to be inserted into the air valve hole, according to an embodiment.

FIG. 12 illustrates a view of the air valve stem inserted into the air valve hole, according to an embodiment.

FIG. 13 illustrates the inner tube being inserted between the wheel and the tire, according to an embodiment.

### DETAILED DESCRIPTION

A tire tool is described that can be used to remove a tube from, or place a tube within, the space between the well of a wheel and a tire. In a particular embodiment, the tool includes two arms that are used to push the tire away from the wheel. The tool's arms are placed in the area of a valve hole in the wheel. Each of the arms is on a different side of the valve hole, and the arms are spaced far enough apart so that an operator can efficiently put a valve stem of the tube into the valve hole in the wheel, or remove the valve stem from the hole, as desired.

The tire tool that is primarily discussed herein is designed specifically for changing tires on motorcycles but it should be readily apparent that the tool can be adapted for a wide variety of different types of tires. For example, tires such as those used on automobiles, bicycles, wagons, toys, models, Segways™, etc., may be susceptible to be worked on by embodiments described herein.

One embodiment provides a tire tool that includes a handle, and a first arm attached to the handle at a first arm proximal end, where the first arm includes a first arm distal end that is distant from the handle. The tire tool also includes a second arm attached to the handle at a second arm proximal end, where the second arm includes a second arm distal end that is distant from the handle, and where the first and second arm distal ends are separated to allow for placement of an air valve stem of an inner tube into an air valve hole of a wheel.

Another embodiment provides a method that includes enabling access to an air valve hole of a wheel using a tire tool. The tire tool includes two arms that push a tire away from the wheel to expose the air valve hole, where each arm of the tire tool is positioned on opposite sides of the air valve hole. The method also includes enabling an air valve stem of an inner tube to be inserted into the air valve hole using the tire tool.

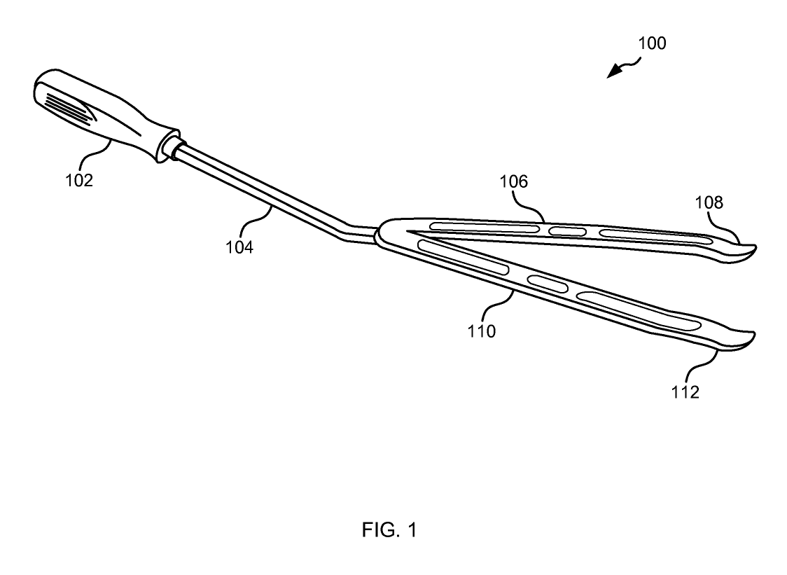

FIGS. 1-5 illustrate different views of an example embodiment. For example, FIG. 1 illustrates a perspective view of a tire tool 100, according to an embodiment. Tire tool 100 includes a handle 102, a handle shaft 104, an arm 106, and an arm 110. As shown, arms 106 and 110 are fixedly attached to handle shaft 104 of handle 102 at the same point. In various embodiments, handle shaft 104 is elongated to provide leverage when separating a tire from a wheel using tire tool 100.

In various embodiments, arms 106 and 110 may include contoured tips 108 and 112. In one embodiment, tips 108 and 112 are curved up slightly to form lips for gripping. Such lips may assist in gripping a tire and/or wheel. In one embodiment, arms 106 and 110 are also turned inward slightly at their tips so that they will be at approximately a right angle to the surface or edge (e.g., of a tire or wheel) that they are trying to grip.

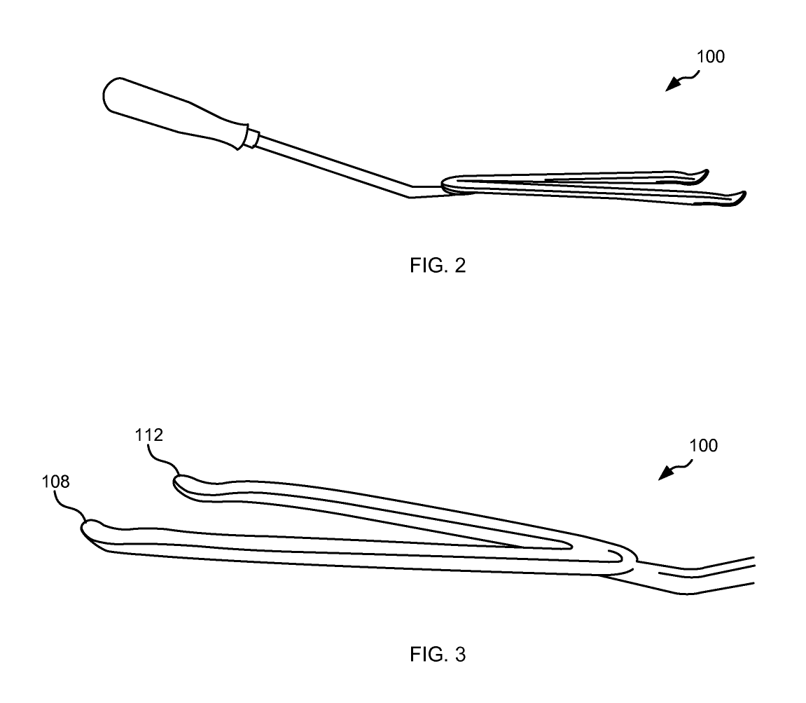

FIG. 2 illustrates a side view of tire tool 100, according to an embodiment. FIG. 3 illustrates a close-up side view of tire tool 100, according to an embodiment. FIG. 3 also illustrates how tips 108 and 112 may be curved up slightly to form lips for gripping.

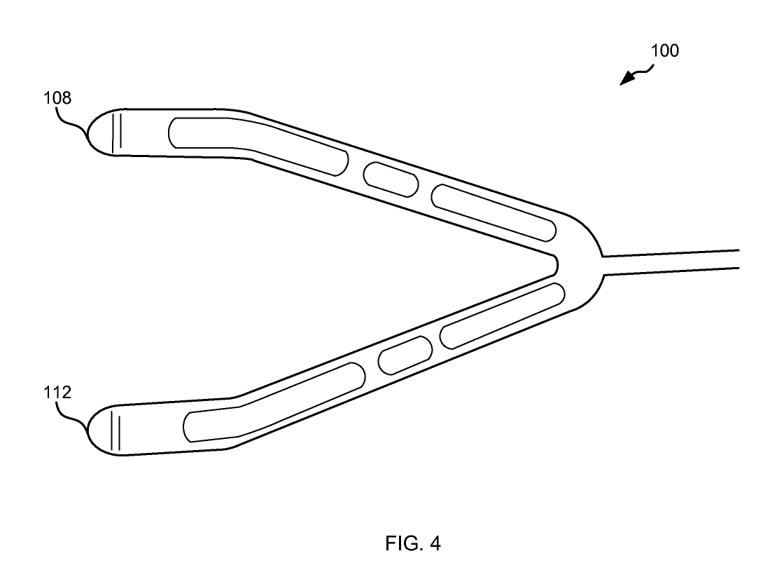

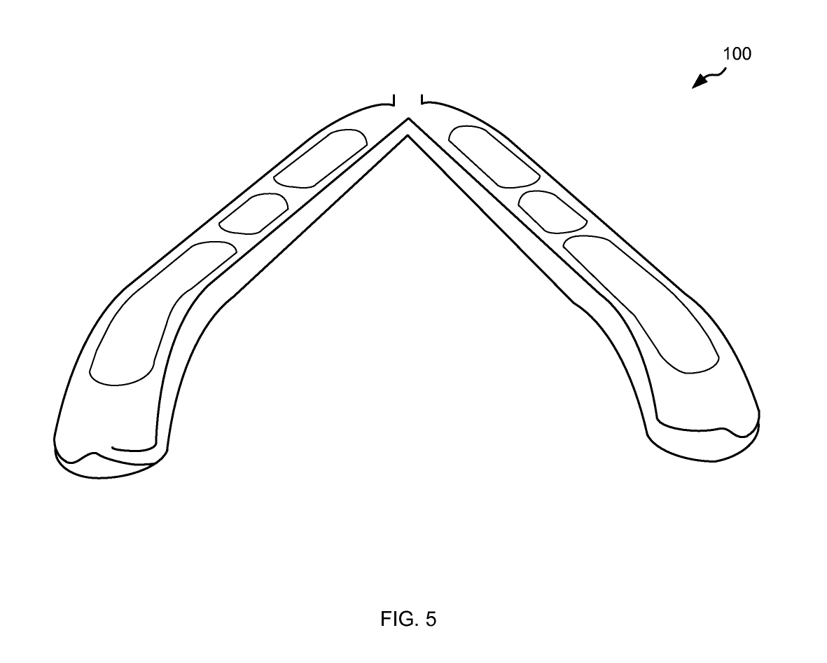

FIG. 4 illustrates a close-up bottom view of tire tool 100, according to an embodiment. FIG. 4 also illustrates how tips 108 and 112 are also turned inward slightly so that they will be at approximately a right angle (e.g., 90 degrees) to the surface or edge (e.g., of a tire or wheel) that they are trying to grip. In various embodiments, tips 108 and 112 may be turned inward at varying degrees to accommodate different edges of different tire or wheel sizes (e.g., less than 90 degrees or more than 90 degrees to the surface or edge that they are trying to grip). FIG. 5 illustrates a close-up top perspective view of tire tool 100, according to an embodiment.

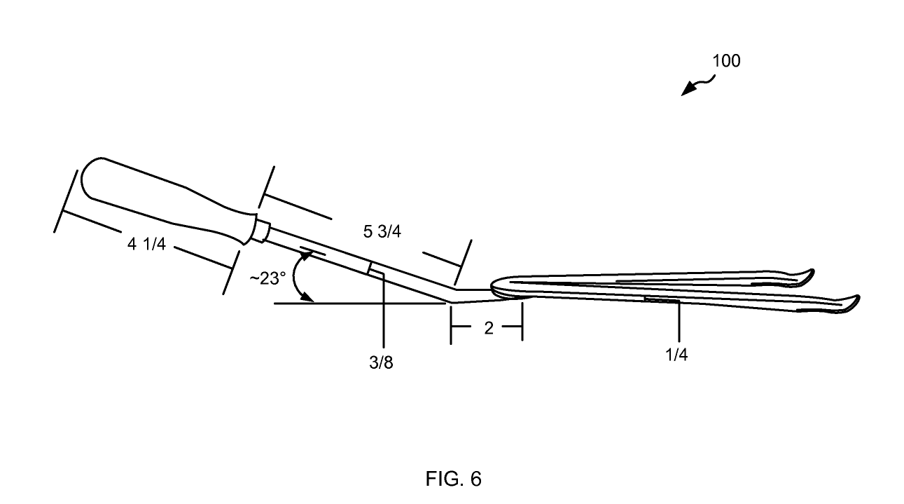

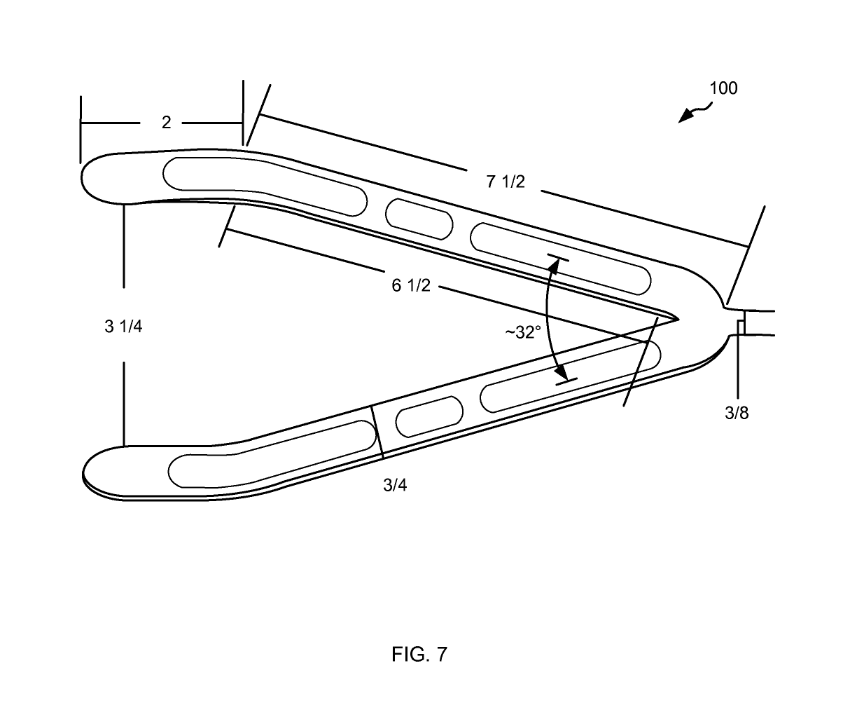

FIGS. 6 and 7 illustrate views similar to those of FIGS. 2 and 4, respectively, except that dimensions and angles are also shown in FIGS. 6 and 7. FIG. 6 illustrates a close-up side view of tire tool 100, including dimensions and angles, according to an embodiment. FIG. 7 illustrates another close-up top view of tire tool 100, including dimensions and angles, according to an embodiment. As shown, all dimensions are in inches. In one embodiment, the separation of the tips may be three and one-quarter inches, as shown if FIG. 7. The separation may vary depending on the specific implementation. For example, in some embodiments, the separation may be at least three inches. In one embodiment, the arms of tire tool may be positioned at an angle to each other of 32 degrees. The specific angle may vary, depending on the specific implementation.

Note that it the dimensions and angles shown in FIGS. 6 and 7 are merely examples, and other dimensions and angles are possible, depending on the specific implementations. For example, it is possible to have many different designs of a tire tool that may fall within the scope of the embodiments described herein. For example, the dimensions, shape, design and other details shown in the figures can be changed. In various embodiments, the tire tool may be made larger or smaller. In various embodiments, the angle of the arms' separation may be increased or decreased, depending on the different applications of the tire tool. In various embodiments, the length of the handle shaft may be increased or decreased to provide more leverage, smaller size, etc. In general, any approach to a handle design may be used.

In various embodiments, the specific bends and contours of the tire tool may be changed. Features may be modified, added or removed from the tire tool, depending on the specific application. For example, in some embodiments, no lip may be provided at the ends of the arms. In some embodiments, the ends may be provided with different material or shapes for specific purposes.

Although this specification presents specific embodiments having somewhat precise measurements, many variations are possible that are still within the scope of embodiments of the invention. For example, variances of 5% to 20% or more for many of the dimensions shown would still result in a similarly effective tool and may even provide additional benefits such as a smaller size, stronger tool, wider area between arms for valve stem manipulation, more leverage, etc. Such variety of embodiments may be desirable especially where different sized wheels, tubes, tires, valve stems, valve holes, etc., are worked on, or where there are other changes in the size, shape or materials of the parts being worked on. The thickness of the tire tool may vary and will depend on the specific implementation.

In the illustrated embodiments, the arms are fixedly attached to the handle or shaft, such as by welding. In other embodiments, the arms can be attached by other means such as by gluing, bolting, etc. The arms can be movably attached (e.g., with a bolt or setscrew) so that the angle between the arms can be changed by a user by hand or by use of a machine.

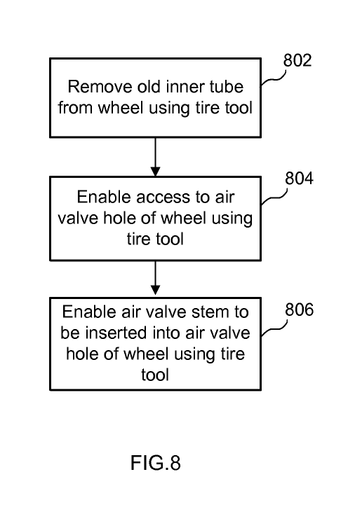

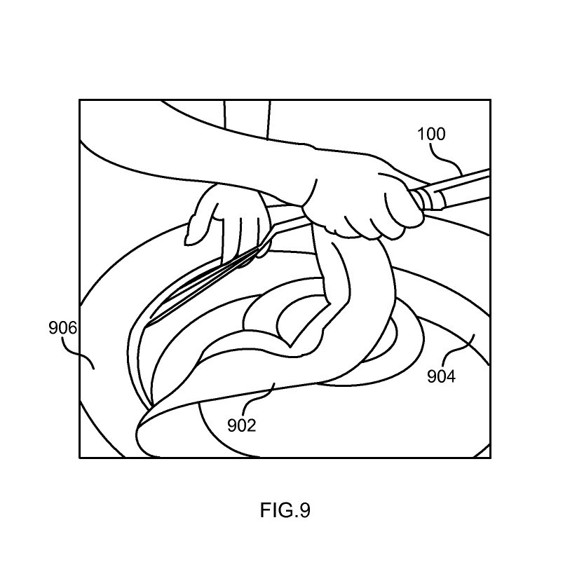

FIG. 8 illustrates an example simplified flow diagram for using tire tool 100, according to an embodiment. FIGS. 9-13 illustrate different views of tire tool 100 being used to remove an inner tube from a wheel, according to various embodiments. The terms inner tube and tire tube are used interchangeably.

Referring to FIGS. 8 and 9, the method is initiated in block 802, where tire tool 100 is used to remove an old inner tube 902 from a wheel 904. FIG. 9 illustrates tire tool 100 being used to remove inner tube 902 from wheel 904, according to an embodiment. As shown, tire tool 100 is being inserted between wheel 904 and a tire 906. Tire tool 100 is then pressed down onto tire 906 such that the tips of the tire tool's arms (hidden from view) grip and separate tire 906 from wheel 904, all the way around to the other side while also keeping the lips of the tire tool's arms against the rim of the wheel. This motion results in FIG. 9 where tire 906 is being pushed away from wheel 904 simultaneously by each arm of tire tool 100.

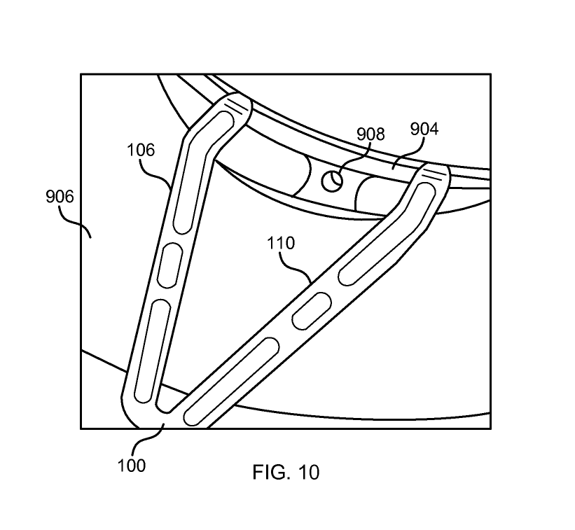

In block 804, tire tool 100 is used to enable access to an air valve hole 908 of wheel 904. FIG. 10 illustrates tire tool 100 being used to enable access to air valve hole 908 of wheel 904, according to an embodiment. In one embodiment, the position of tire tool 100 on wheel 904 is chosen such that each arm 106 and 110 of tire tool 100 is in the area of air valve hole 908 in wheel 904. Each arm 106 and 110 may be positioned on an opposite side of air valve hole 908. As shown, air valve hole 908 in wheel 904 can be easily seen between arms 106 and 110 of tire tool 100. FIG. 10 also shows tire 906 being pushed away from wheel 904 simultaneously by each arm 106 and 110 of tire tool 100.

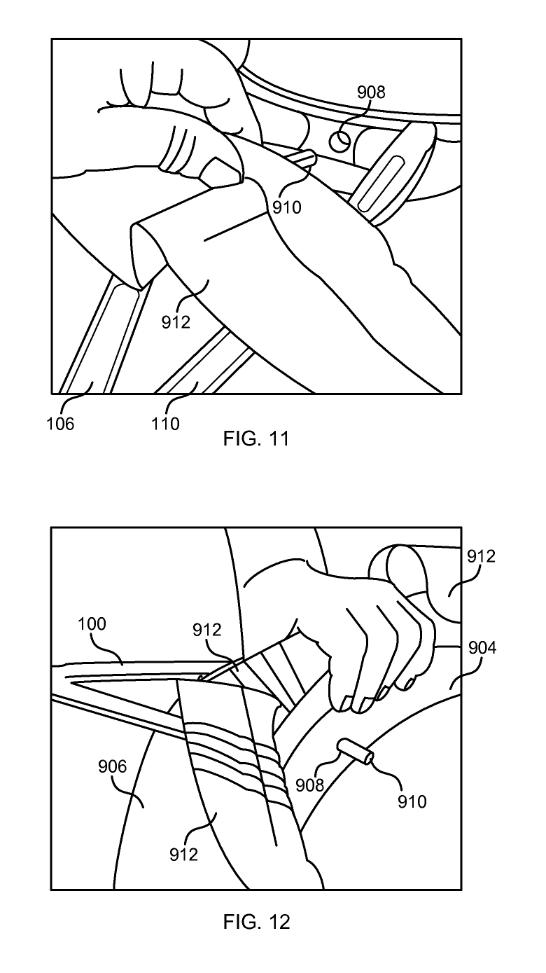

In block 806, tire tool 100 is used to enable an air valve stem 910 of a new inner tube 912 to be inserted into air valve hole 908. FIG. 11 illustrates a close-up view of tire tool 100 being used to enable air valve stem 910 of inner tube 912 to be inserted into air valve hole 908, according to an embodiment. As shown, tire tool 100 provides adequate access to air valve hole 908 so that air valve stem 910 can be inserted into air valve hole 908. As shown, arms 106 and 110 of tire tool 100 are in an area near air valve hole 908 and on opposite sides of valve hole 908. This allows for placement of air valve stem 910 between the tips of arms 106 and 110 of tire tool 100, and allows for placement of air valve stem 910 into air valve hole 908.

The operator (or “user”) maintains pressure on the handle of tire tool 100 with one hand to keep tire 906 away from air valve hole 908 while using the other hand to insert air valve stem 910 into air valve hole 908. The user inserts air valve stem 910 into air valve hole 908 while maintaining downward pressure on tire tool 100. Note that other embodiments of the invention can provide variations such as using a weight, clamp, or machine or object having a slot, edge, etc., to hold tire tool 100 in place so that the user does not have to maintain downward pressure. Many variations are possible.

FIG. 12 illustrates a view of air valve stem 910 inserted into air valve hole 908, according to an embodiment. Once air valve stem 910 is inserted into air valve hole 908, the rest of inner tube 912 can be pushed into the space between wheel 904 and tire 906.

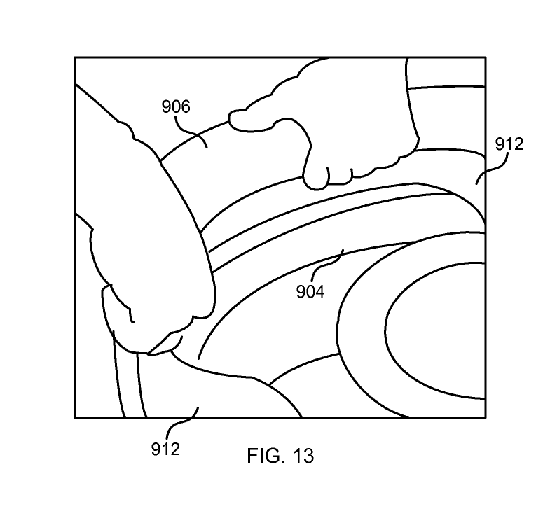

FIG. 13 illustrates inner tube 912 being inserted between wheel 904 and tire 906, according to an embodiment. Tire tool 100 (not shown) may also be used to install tire 906 around wheel 904 after inner tube 912 is inserted between the well of wheel 904 and tire 906.

It should be apparent that various steps described herein may be modified or omitted. Also, steps may be added without departing from the scope of the invention.

Although the illustrations are for a manually operated tool, in other applications the tire tool may be used by a machine in an automated fashion. More than 2 arms may be employed. The arms need not be of the design shown here but can be joined together so that they form a single “body.” For example, in some embodiments, much of the space between the arms shown in FIGS. 1-7 may be filled in with material such as metal or plastic as long as the user is able to insert the valve stem into the valve hole between the arms. In other words, the need not be “arms” per se in some embodiments. For example, in some embodiments, there may be a planar body piece with a hole, for example.

Any suitable materials and methods of manufacture can be used to create embodiments of the invention. For example, the tool can be made of steel, iron, aluminum, carbon fiber, etc. Manufacture can include drop forging, machining, casting, fabricating, etc. Any suitable combination of materials and manufacture can be used.

Although the description has been described with respect to particular embodiments thereof, these particular embodiments are merely illustrative, and not restrictive. For example, embodiments of the tire tool described herein may be used for various steps involving the replacement of an inner tube of a tire. In one embodiment, for example, a method may include: placing a tire tube around a wheel by pushing aside a tire, where the tire tube includes an air valve stem, where the wheel includes an air valve hole comprising a through opening in the wheel for accepting the air valve stem. The method may also include using the tire tool such that two arms of the tire tool push the tire away from the wheel to expose the air valve hole, where each arm of the tire tool is in an area near the air valve hole and on opposite sides of the air valve hole. The method may also include placing the air valve stem into the air valve hole, removing the tire tool from the area of the air valve hole, and placing the tire tube around the wheel.

Reference throughout this specification to “one embodiment,” “an embodiment,” or “a specific embodiment” means that a particular feature, structure, or characteristic described in connection with the embodiment is included in at least one embodiment of the present invention and not necessarily in all embodiments. Thus, respective appearances of the phrases “in one embodiment,” “in an embodiment,” or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Additionally, any signal arrows in the drawings/figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow “a,” “an,” and “the” include plural references unless the context clearly dictates otherwise. Furthermore, as used in the description herein and throughout the claims that follow, the meaning of “in” includes “in” and “on” unless the context clearly dictates otherwise.

The foregoing description of illustrated embodiments of the present invention, including what is described in the Abstract, Field of the Invention, Title, or Summary, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A tire tool comprising:
a handle;
a first arm attached to the handle at a first arm proximal end, wherein the first arm includes a first arm distal end that is distant from the handle; and
a second arm attached to the handle at a second arm proximal end, wherein the second arm includes a second arm distal end that is distant from the handle, and wherein the first and second arm distal ends are separated to allow for placement of an air valve stem of an inner tube into an air valve hole of a wheel.

2. The tire tool of claim 1, wherein the first and second arm distal ends are separated to allow for placement of the air valve stem between the first arm distal end and the second arm distal end.

3. The tire tool of claim 1, wherein the first arm proximal end and the second arm proximal end are fixedly attached to the handle at the same point.

4. The tire tool of claim 1, wherein the handle includes an elongated shaft.

5. The tire tool of claim 1, wherein the handle includes an elongated shaft, and wherein the first arm and the second arm are attached to the elongated shaft.

6. The tire tool of claim 1, wherein the separation of the first and second arm distal ends is at least three inches.

7. The tire tool of claim 1, wherein the first arm and the second arm are positioned at an angle to each other of at least 32 degrees.

8. The tire tool of claim 1, wherein the first arm distal end and the second arm distal end are each formed with a bend to assist in gripping.

9. A tire tool comprising:
a handle;
a first arm attached to the handle at a first arm proximal end, wherein the first arm includes a first arm distal end that is distant from the handle; and
a second arm attached to the handle at a second arm proximal end, wherein the second arm includes a second arm distal end that is distant from the handle, wherein the first and second arm distal ends are separated to allow for placement of the air valve stem between the first arm distal end and the second arm distal end and to allow for placement of an air valve stem of an inner tube into an air valve hole of a wheel, and wherein the first arm distal end and the second arm distal end are each formed with a bend to assist in gripping.

10. The tire tool of claim 9, wherein the first arm proximal end and the second arm proximal end are fixedly attached to the handle at the same point.

11. The tire tool of claim 9, wherein the handle includes an elongated shaft.

12. The tire tool of claim 9, wherein the handle includes an elongated shaft, and wherein the first arm and the second arm are attached to the elongated shaft.

13. The tire tool of claim 9, wherein the separation of the first and second arm distal ends is at least three inches.

14. The tire tool of claim 9, wherein the first arm and the second arm are positioned at an angle to each other of at least 32 degrees.

15. A method comprising:
enabling access to an air valve hole of a wheel using a tire tool, wherein the tire tool includes two arms that push a tire away from the wheel to expose the air valve hole, and wherein each arm of the tire tool is positioned on opposite sides of the air valve hole; and
enabling an air valve stem of an inner tube to be inserted into the air valve hole using the tire tool.

16. The method of claim 15, wherein the access enabling comprises pushing the tire away from the wheel at two locations simultaneously.

17. The method of claim 15, further comprising removing an old inner tube from the wheel using the tire tool.

18. The method of claim 15, further comprising installing the tire around the wheel using the tire tool.

19. The method of claim 15, wherein the tire tool includes:
a first arm attached to a handle at a first arm proximal end, wherein the first arm includes a first arm distal end that is distant from the handle; and
a second arm attached to the handle at a second arm proximal end, wherein the second arm includes a second arm distal end that is distant from the handle, and wherein the first and second arm distal ends are separated to allow for placement of an air valve stem of an inner tube into an air valve hole of a wheel.

20. The method of claim 15, wherein the first and second arm distal ends are separated to allow for placement of the air valve stem between the first arm distal end and the second arm distal end.
